(19) United States
(12) Patent Application Publication
(10) Pub. No.: US 2008/0259724 A1
(43) Pub. Date: Oct. 23, 2008

(54) Rotating Gap Granulation

(75) Inventors: Reinhard Mowka, Schwarzenbek (DE); Frank Eric Sandfort, Paderborn (DE)

Correspondence Address: BARNES & THORNBURG LLP, 11 SOUTH MERIDIAN, INDIANAPOLIS, IN, 46204, US

(73) Assignee: Gebr. Lodige Maschinenbau-GmbH, Paderborn (DE)

(21) Appl. No.: 11/628,287

(22) PCT Filed: Mar. 14, 2005
(86) PCT No.: PCT/EP2005/051125

§ 371 Date: Dec. 6, 2007

(30) Foreign Application Priority Data
Jun. 3, 2004 (DE) 102004027239.5

(51) Int. Cl. B01F 11/00

(52) U.S. Cl. 366/276

(57) ABSTRACT

The invention relates to method for producing granules. Methods for producing granules are diversely used in chemical process engineering, for example, for producing starting materials for shaped bodies and, to be precise, for brake linings and sealing elements. The inventive method for producing granules from fibrous, powdery and liquid components in a mixing receptacle of a mixer provides that by rotating at least one mixing tool inside the mixing receptacle in a first direction of rotation, a compacting effect upon the components is achieved between the mixing tool and a wall section of the mixing receptacle. For example, this is achieved by appropriately sloped surfaces on the mixing tool, which push the components located inside the mixing receptacle toward a wall section. The inventive compacting effect enables an improved formation of granules. The mixer can be a conventional vertical mixer. The granulates have an advantageously rounded shape and size, for example, of the size of matchstick heads. In addition, the granule is comparatively dust-free and homogeneous. The granule thus depicts an improved starting product, e.g. for shaped bodies and, to be precise, for braking linings and sealing elements.

The present invention relates to a method for producing granules. Methods for producing granules are diversely used in chemical process engineering, for example, for producing the starting material for molding materials or molded articles, namely, in particular for brake linings as well as sealing elements.

Vertical mixers, for example, with a fixed cylindrical mixing container and with a mixing tool rotating horizontally on the bottom of the receptacle are used for processing powdery, fibrous as well as liquid components into granules. Vertical mixers are known from the state of the art. In these machines, the mixing and kneading effect is generally achieved by mixing tools rotating horizontally about a vertical axis in the mixing receptacle. In general, these mixing tools are formed similar to propellers. The direction of rotation of the mixing tools or the position of the surfaces arranged on the mixing tools is adjusted to suit the mixing processes usually executed by the mixing tools. Both are then selected so that the components located in the mixing tool are separated from the wall portions and conveyed or pushed towards the interior of the mixing receptacle. For example, a mixing tool, which is disposed adjacent to the bottom and which comprises blades, rotates in a vertical mixer; the edge of the blades that is in front relative to the direction of rotation is closer, respectively, to the bottom, than the rear edge. In the known usage of these apparatuses for producing granules, i.e. inter alia in the usual direction of rotation, the granulate products do not, however, exhibit the fine granulation desired. The individual particles are not sufficiently rounded and/or the mixing product has a dust content that is too high.

It is the object of the invention to provide an improved method for producing granules.

This object is achieved by a method having the features of the claims 1 or 2. Advantageous embodiments follow from the dependent claims.

The method according to the invention for producing of granules from fibrous, powdery as well as liquid components in a mixing receptacle of a mixer provides that a compacting effect on the components between the mixing tool and a wall portion of the mixing receptacle is achieved due to at least one mixing tool rotating in a first direction of rotation in the mixing receptacle. The components, that is, the starting material for the granules, are, as a rule, dry substances such as powders and fibers as well as liquids. The mixing receptacle can be formed in a conventional manner. Preferably, it is formed substantially cylindrically or conically, tapering towards the top. Moreover, at least one mixing tool, which is, in particular, disposed at the bottom of the mixing receptacle, is provided that rotates in the mixing receptacle. Preferably, the mixing tool is driven by a motor via a shaft that protrudes vertically into the mixing receptacle, as in a conventional vertical mixer.

An improved granule formation is achieved by the compacting effect according to the invention. In comparison to the prior art described at the beginning, the time for producing the granules is short. The granules have an advantageously rounded shape and size. Moreover, the granules are comparatively dust-free and homogeneous. Thus, the granules represent an improved starting material for molded articles, in particular for brake linings as well as sealing elements. In contrast to the prior art described at the beginning, the granules do not unmix after they have been produced. If the desired molded article is pressed from the granules, the number of rejects of products is small, compared to the above-mentioned prior art, due to the good properties of the granules. The granules can be pressed comparatively easily.

The above-mentioned advantages can be achieved by means of a method in which granules are produced from fibrous, powdery and/or liquid components in a mixing receptacle of a mixer by parts of the components being conveyed in the direction of an adjacent wall portion of the mixing receptacle by rotating surfaces of a mixing tool, which are sloped in the direction of rotation. For example, the mixing tool has propeller-like blades having such surfaces, by means of which the components are pushed or conveyed from the surfaces towards the closest wall portion or bottom portion of the mixing receptacle. The individual surface may be plane or curved.

Surprisingly, it was shown that a conveying of the components to be granulated towards a wall portion or bottom portion of the mixing receptacle, in particular towards the bottom, significantly improves the granulating effect. For this purpose, conventional vertical mixers are preferably used whose direction of rotation is set appropriately during the production of the granules, i.e. in accordance with a first direction of rotation that brings about a compaction by conveying the components from the mixing tool towards the wall or bottom. The granules thus produced have an advantageously rounded shape and size, for example, in the size of a match head. Moreover, the granules are comparatively more dust-free and more homogeneous. Thus, the granules represent an improved starting material for molding materials or molded articles, in particular for brake linings as well as sealing elements.

If the compacting effect is achieved between the mixing tool and the bottom by rotating in the first direction of rotation, a rounded bottom, for example a rounded disk or a dished boiler end is to be preferred over a flat bottom, which is also possible, as experiments have shown. Blades of the mixing tool with which the compacting effect is achieved during the first direction of rotation, then preferably have a shape that is adapted to the shape of the bottom. In the case of a rounded bottom, the blades substantially extend parallel to the bottom and are thus also rounded.

The granulation is substantially controlled by the parameters pressure, rotational speed of the mixing tool, as well as temperature. Among other things, it may possibly also happen, depending on the starting materials or starting components, that the result of the granulation cannot be improved arbitrarily by a pressure increase that is due to, for example, change of the geometry of the surface or the mixing receptacle, by the arrangement of the mixing tool, and above all by the velocity of movement of the mixing tool. In that case, the material may disadvantageously stick to the wall of the mixing receptacle instead. It is the responsibility of the person skilled in the art to find an optimal setting by varying the pressure and temperature, and, if necessary, by a prior dehumidification of the starting components with associated temperature increase. When the parameters are set suitably, the components separate from the wall of the mixing receptacle, and an optimal formation of granules is accomplished. The respective setting depends on the components used.

A further embodiment of the method provides that the compacting effect is achieved by a mixing tool that is substantially adapted, on side facing the wall or bottom of the mixing receptacle, to the shape of the wall or bottom of a portion of the mixing receptacle. The distance of the mixing tool to the portion of the wall or bottom, or the gap therebetween, is thus substantially constant. Thus, the mixing tool moves in a parallel plane relative to the wall portion or bottom portion.

In a further embodiment, the mixing tool moves on a surface of revolution that maintains a uniform distance to a curved wall portion. For example, the bottom of the mixing receptacle is spherically dished towards the outside, i.e. rounded, and the mixing tool has blades that are correspondingly bent upwards. In comparison to the prior art mentioned at the beginning, a particularly homogeneous formation of granules is achieved by this uniform distance. Depending on the surface geometry and speed, the distance can be optimized so that, on the one hand, the pressure generated does not become to high in order to avoid the sticking described above, and that, on the other hand, an optimal formation of granules is achieved.

In another embodiment of the method according to the invention for producing granules, a bonding agent is added to the components. For example, this can be wax, liquid resin such as phenolic resin and its derivatives, liquid rubber, latex and dissolved thermoplastics such as polyvinyl alcohol. Because of the particular properties of these components, a bonding effect with the rest of the components occurs during the treatment in the mixing receptacle, due to friction and/or heat. For example, a wax added as a bonding agent melts because of the heat generated by the movement or due to heat supplied from the outside, and thus binds dust particles between the components that are to be granulated. A particularly homogenous formation of granules and particularly dust-free granules are thus achieved.

Another embodiment provides that the components to be mixed are heated. For example, heating coils are disposed around the mixing receptacle. The temperature can thus be set particularly easily and quickly, and an optimal setting of the mixing parameters can thus be ensured.

There is little unmixing of the granules produced. Therefore, the granules are stable and have improved pressing properties. The granules can be manufactured very quickly. The charge time and thus the production cost, accordingly, are low. The number of rejects of the molded articles produced therefrom, accordingly, is small. Advantageously, the granules are pressed into brake linings or sealing elements.

Moreover, it is advantageously provided that the direction of movement of the mixing tool is reversed sequentially. For example, the direction of movement that is opposite to the first direction of rotation is used for pulling apart fibers and/or, to mix components prior to granulation.

Fibrous components bunch together like cotton wool. Therefore, it is advantageous to begin the production of granules in a first step by first putting the fibrous components into the mixing container and to rotate the mixing tool in the opposite direction from the first direction of rotation, thus pulling apart the fibers, preferably at relatively high rotational speed. In order to improve this effect, the mixing tool preferably has blades in addition to the blades with which the compacting effect is achieved. Therefore, the blades are arranged in several planes, seen from the axis of rotation.

In an advantageous embodiment of the invention, further components are added to the mixing container in a second step, namely mainly liquid components. The point of this second step is to mix together the components located in the mixing receptacle. The desired result can best be achieved by rotating the mixing tool in a direction opposite to the first direction of rotation, namely preferably with a reduced rotational speed compared to the rotational speed set during the first step.

In order to improve the aforementioned thorough mixing, the mixing tool also has the aforementioned additional blades, that is, a plurality of blades, which, seen from the axis of rotation, are arranged on different planes. The additional blades are preferably shaped differently and are arranged in several planes along the axis of rotation.

When the components located in the mixing receptacle have been mixed sufficiently, the production of the granules begins in a third step. For this purpose, the direction of rotation of the mixing tool is changed. The mixing tool now turns in accordance with the first direction of rotation. In the process, the components are compacted in the direction of the bottom or wall of the mixing container, namely by blades that are close to the bottom or walls of the mixing container.

The invention is explained further by means of the following figures.

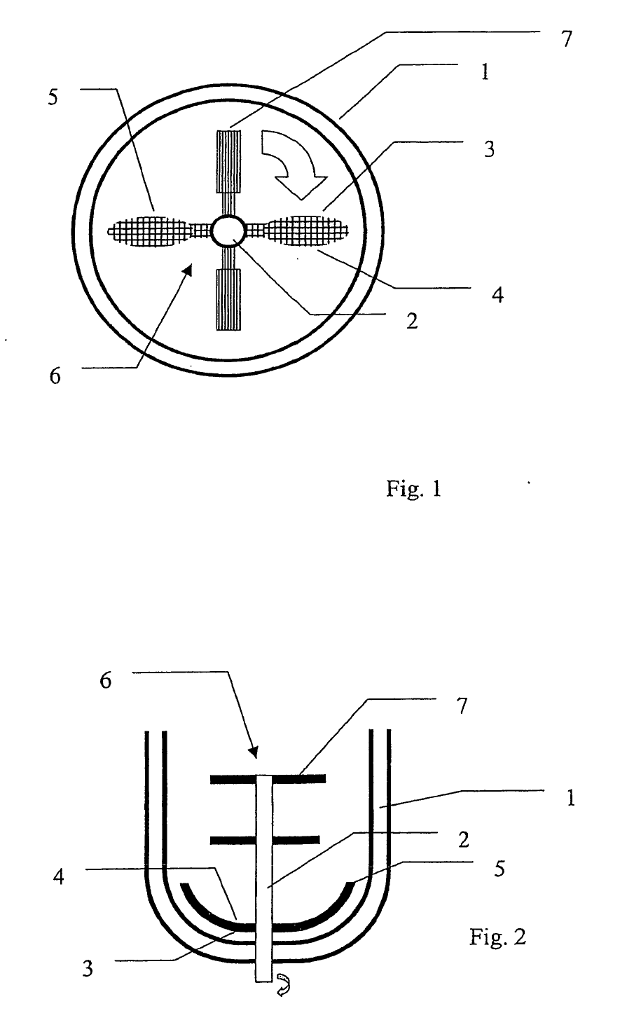

FIG. 1 shows a top view of the mixer used in the method for producing granules.

FIG. 2 shows a sectional view of the mixer used in the granulation method according to the invention.

A mixing tool 6 which is made to rotate via an axle 2 is disposed in the receptacle 1. An electromotive drive can be provided for driving the axle 2. The mixing tool 6 has two propeller-like blades 5 arranged close to the bottom. For reasons concerning the transmission of forces is to be preferred that the mixing tool 6 has only two blades 5 that are arranged adjacent to the bottom of the mixing receptacle. The blades 5 have surfaces between the edges 3 and 4. The surface on the underside of the respective blade 5 have a compacting effect on the components, which are not shown here and are located between the bottom of the mixing receptacle and the surfaces, during the rotation of the blades 5 in the first direction of rotation. In the present case, and given the first direction of rotation marked with arrows, the edge 3 is arranged closer to the bottom of the receptacle than the edge 4, due to the appropriate slope of the surfaces.

The temperature control of the mixing container is done by means of the double wall. Suitable temperature-controlled liquids can also be routed through it.

Further blades 7 are provided above the blades 5 that are arranged close to the bottom. These additional blades assist in the production of the granules from the individual components.

FIG. 2 shows the sectional view of the mixer sketched in FIG. 1. The direction of rotation of the mixing tool 6 in the receptacle 1 is illustrated by the ring-shaped arrow at the axle 2. The pressure on the components and thus, the compacting effect, is the larger, the faster the rotation in the first direction of rotation is. If the direction of rotation of the mixing tool is changed, the surfaces of the blades 5 that point towards the interior of the mixing receptacle and that lie between the edges 3 and 4 push upwards, i.e. towards the components not shown here, which are located above the mixing tool 5.

As the FIG. 2 illustrates, the mixing container has a rounded bottom. The blades 5 are rounded accordingly.

It is not necessary to mix the individual components with each other in the mixing container. It is also possible to put the mixture of the components that is already prepared into the mixing container and start producing the granules immediately. In that case, the mixing tool therefore rotates in a direction opposite to the direction of rotation right from the beginning.

The mixing receptacle is emptied after the granules have been produced. Rotating the mixing tool in a direction opposite to the first direction of rotation is advantageous.

The invention is further explained below by way of an example relating to the production of a friction lining. The following starting materials were used:

| Raw material group | Raw material | wt-% |
|---|---|---|
| Binding agent | Phenolic resin | 9.00 |
| | Liquid rubber | 3.00 |
| | Cross-linking agent | 0.50 |
| Lubricant | Antimony sulphide | 6.00 |
| | Molybdenum sulphide | 2.00 |
| | Graphite | 5.00 |
| | Coke | 9.00 |
| Abrasives | Aluminum oxide | 4.00 |
| | Cromite | 3.00 |
| | Iron oxide | 5.00 |
| Fillers | Mica powder | 6.00 |
| | Lime | 3.00 |
| | Chalk | 3.00 |
| | Barium sulphate | 8.00 |
| Fibrous materials | Aramid fibers | 2.00 |
| | Cellulose | 1.00 |
| | Mineral fibers | 3.00 |
| Metals | Steel fiber | 14.50 |
| | Copper powder | 8.00 |
| | Brass powder | 5.00 |
| Total | | 100.00 |

The formulations for friction linings that can be used differ only slightly from the conventional formulations. Advantageously, they have a plasticizable proportion of 7-25 wt-%. Particularly good results can be achieved with a plasticizable proportion of 9-17 wt-%. The plasticizable components can consist of solid/liquid phenolic resins and/or their derivatives, of liquid rubber and/or latices and of solid/liquid thermoplastics. The addition of pure water has also proved suitable for binding dust and for granulation at higher proportions of phenolic resins.

A vertical mixer commercially available under the name Papenmeier® Schnellmischer TSHK 160 was used. The diameter of the container of the mixing container belonging thereto is 600 mm. The height of the container is 644 mm. The ratio of height to diameter is 1.07. Good results can also be achieved with a ratio of height to diameter of between 0.9 to 1.2. The mixing receptacle has a rounded bottom. The mixing tool has a two-armed, sickle-like tool, which moves over the bottom, with ends that are broadened like spoons, that is, with two blades. It thus comprises two blades arranged adjacent to the bottom. However, the tool can also have three arms, that is, three blades. In that case, however, the transmission of forces may present some problems. The distance between the bottom tool, i.e. the blades, and the bottom of the container, is 15 mm. A distance of between 5-25 mm has also proved useful. The angle of the spoon-like ends of the bottom tool is 35°. Further useful angles can be between 15° and 60°. Two further sword-like tools are attached to the axle of the mixing tool. The ends are shaped so that they push the product or the components down in both directions of rotation. The rotational speed of the mixing tool during granulation was 600 to 400 m⁻¹. Rotational speeds of 200 to 800 min⁻¹ were also possible. It was found that, depending on the size of the machine, the circumferential speed should be 6-29 m/s, in particular 12-20 m/s. The mixing receptacle has a double wall, by means of which a temperature of 5-95° C., preferably of 35-40° C. was set. When selecting the temperature, attention must be paid to the temperature of the product staying below the critical hardening temperature of the phenolic resins and their derivatives, whose fixing is only to be carried out during sintering after pressing. The critical temperature is generally above 130° C.

The components to be granulated are put into the mixing receptacle of the mixer, which has a circular diameter. In a first step, the dry substances, that is, in particular, the fibers, are put into this mixing receptacle. In a second step, the liquid components, in particular, are added. When the components have been mixed with each other, the direction of rotation of the mixing tool is changed, and the production of the granules takes place in a third step. The compacting effect is achieved then. When the granules have been produced, the direction of rotation is expediently changed once again, and the removal begins. It is advantageous to carry out the removal of the granules when the mixing tool is not rotated in the first direction of rotation. In this manner, it is avoided that the continued compaction degrades the result again. If the mixing tool is rotated in a direction opposite to the first direction of rotation, the removal is facilitated. Further details for the production are apparent from the following table.

| | Rotational | Direction | Time |
|---|---|---|---|
| Process | speed (min⁻¹) | of rotation | (min) |
| Filling the mixer with all dry | 0 | | |
| substances | | | |
| Homogenization and fiber | 600 | right- | 1.0 |
| separation | | handed | |
| Addition of liquid latex and | 400 | right- | 2.0 |
| homogenization | | handed | |
| Granulation | 400 | left- | 1.0 |
| | | handed | |
| Emptying | 600 | right- | 0.5 |
| | | handed | |
| Process time without filling | | | 4.5 |

The direction of rotation “left-handed” here corresponds to the first direction of rotation. The desired granules having a high quality were available after only 4.5 minutes.

1. A method for producing granules from materials which are at least one of powdery, fibrous and liquid in a mixing receptacle of a mixer, wherein said materials are put into the mixing receptacle, and wherein a mixing tool in the mixing receptacle is rotated in a second direction opposite to a first direction of rotation of the mixing tool until the materials are mixed with each other,
wherein a compacting effect on the materials between the mixing tool and a wall portion of the mixing receptacle is achieved by rotating the one mixing tool in the mixing receptacle in the first direction of rotation and wherein granules are produced thereby from the mixture.

2. The method according to claim 1, wherein the materials are pushed, at least partially, by rotating surfaces on the mixing tool, which surfaces are sloped relative to the direction of rotation, towards an adjacent wall portion of the mixing receptacle, wherein the wall portion is a bottom of the receptacle, wherein the distance between blades of the mixing tool and the bottom of the receptacle is between 5 and 25 mm, and wherein the granules are produced from the mixed materials.

3. The method according to claim 1 wherein the compacting effect is achieved by the mixing tool being substantially adapted, on the side facing the wall portion of the mixing receptacle, to the shape of the wall portion of the mixing receptacle.

4. The method according to claim 1 wherein a dust-binding agent is added to the materials.

5. The method according to claim 1 wherein the materials are heated.

6. The method according to claim 1 wherein dry substances are first put into the mixing receptacle.

7. The method according to claim 6 wherein, subsequent to the addition of dry substances into the mixing receptacle, liquid components are added into the mixing receptacle.

8. The method according to claim 7, wherein, prior to the addition of liquid components, the mixing tool is rotated in the second direction faster than during and after the addition of liquid components.

9. A method for producing a brake lining using the method for producing granules according to claim 1.

10. A mixer having a mixing receptacle with a rounded bottom, a mixing tool located therein, the distance between the blades of the mixing tool and the bottom of the receptacle being between 5 and 25 mm, control means that cause the mixing tool to rotate in a second direction in a first step, means for feeding dry substances during the first step, means for subsequently feeding liquid components during a second step, the control means causing the mixing tool to rotate in a first direction of rotation opposite the second direction in a third step so that granules are created on the bottom of the receptacle due to compaction.

11. The apparatus according to claim 10 wherein the control means causes the mixing tool to rotate faster during the first step than during the second step.

12. The apparatus according to claim 10 wherein the mixing tool comprises two blades sloped relative to the bottom, the two blades being otherwise substantially parallel relative to the bottom of the mixing receptacle.

13. The apparatus according to claim 12 wherein the mixing tool has two additional blades above the two sloped blades.

14. The apparatus according to claim 10 wherein the mixer is a vertical mixer.

15. Granules for producing a brake lining, the granules made from materials which are at least one of powdery, fibrous and liquid, in a mixing receptacle of a mixer, wherein said materials are put into the mixing receptacle, and wherein a mixing tool in the mixing receptacle is rotated in a second direction opposite to a first direction of rotation of the mixing tool until the materials are mixed with each other, wherein a compacting effect on the materials between the mixing tool and a wall portion of the mixing receptacle is achieved by rotating the one mixing tool in the mixing receptacle in the first direction of rotation and wherein granules are produced thereby from the mixture, the granules having a plasticizable proportion of 7-25 wt-%.

16. The method according to claim 2 wherein the compacting effect is achieved by the mixing tool being substantially adapted, on the side facing the wall portion of the mixing receptacle, to the shape of the wall portion of the mixing receptacle.

17. The method according to claim 2 wherein a dust-binding agent is added to the materials.

18. The method according to claim 3 wherein a dust-binding agent is added to the materials.

19. The method according to claim 16 wherein a dust-binding agent is added to the materials.

20. The method according to claim 2 wherein the materials are heated.
